(19) United States
(12) Patent Application Publication
(10) Pub. No.: US 2012/0303840 A1
(43) Pub. Date: Nov. 29, 2012

(54) DMA DATA TRANSFER MECHANISM TO REDUCE SYSTEM LATENCIES AND IMPROVE PERFORMANCE

(76) Inventor: Gurvinder P. Singh, Pimple Saudagar (IN)

(21) Appl. No.: 13/114,303

(22) Filed: May 24, 2011

(51) Int. Cl. G06F 13/28

(52) U.S. Cl. 710/22

(57) ABSTRACT

A method of implementing a data transfer mechanism to reduce latencies and improve performance comprising the steps of reading a first data element, storing the first data element, and writing the first data element. The first data element may be read from a host. The first data element may be stored in a storage portion of a controller. The first data element may be written to a first destination device. The first data element may also be written to a second destination device prior to deleting the first data element from the storage portion.

### FIELD OF THE INVENTION

The present invention relates to data storage generally and, more particularly, to a method and/or apparatus for implementing a DMA data transfer mechanism to reduce system latencies and improve performance.

### BACKGROUND OF THE INVENTION

Conventional Direct Memory Access (DMA) transfers in a multicasting environment include implementing “N” scatter gather lists (SGLs). A fair chance needs to be given to each SGL at a particular frame boundary, such as 1K, 2K or any other programmable number. DMA blocks fetch the elements for a particular SGL for a particular data transfer to the host memory. Scatter gather elements (SGEs) of the SGLs can be large enough to complete the data transfer. However, in multicasting the transfer needs to be terminated at a particular boundary to begin servicing the next SGL. As a result, if the hardware cannot access the SGEs, a significant overhead can be created. The overhead is created in a case where the hardware returns to the same SGL, and the hardware needs to fetch the same elements of the SGL to start the data transfer from the earlier point. The data transfer can use large amounts of bandwidth on the system bus multiple times by repeating the same cycle, thereby introducing the inefficiency in the system.

The above mentioned conventional method has several disadvantages. The system bus is accessed multiple times and therefore makes the bus unavailable to other processes. The overall data throughput is reduced and makes the system inefficient. Conventional methods also overwork the capabilities of hardware resources.

It would be desirable to implement an efficient DMA data transfer mechanism to reduce overall system latencies and/or improve performance.

### SUMMARY OF THE INVENTION

The present invention concerns a method of implementing a data transfer mechanism to reduce latencies and improve performance comprising the steps of reading a first data element, storing the first data element, and writing the first data element. The first data element may be read from a host. The first data element may be stored in a storage portion of a controller. The first data element may be written to a first destination device. The first data element may also be written to a second destination device prior to deleting the first data element from the storage portion.

The objects, features and advantages of the present invention include providing a DMA data transfer mechanism that may (i) reduce system latencies and/or improve performance, (ii) be used in a multicasting environment, (iii) be implemented using a Hard Disk Drive (HDD) and/or tape storage peripherals (e.g. controllers, preamplifiers, interfaces, power management, etc.), (iv) be implemented without any change to the existing system, (v) be implemented seamlessly to other systems, (vi) be implemented without changing the controller firmware, (vii) be implemented as a completely hardware based approach and/or (viii) be easy to implement.

### BRIEF DESCRIPTION OF THE DRAWINGS

These and other objects, features and advantages of the present invention will be apparent from the following detailed description and the appended claims and drawings in which:

FIG. 1 is a block diagram of the present invention;

FIG. 2 is a more detailed diagram of the present invention; and

FIG. 3 is a flow diagram illustrating a process for implementing the present invention.

### DETAILED DESCRIPTION OF THE PREFERRED EMBODIMENTS

The present invention may provide an efficient Direct Memory Access (DMA) data transfer mechanism that may be useful in a multicasting environment. System efficiency may be improved by reducing the need to repeatedly fetch one or more scatter gather elements (SGEs) of a given scatter gather list (SGL) over a general system bus (e.g., processor local bus (PLB)) in a multicasting environment. In one example, the multicasting environment may specify that all of the SGLs need to be given fair chance for data transfer at a given point of time. Frequent access to the system bus may be reduced by storing the SCEs of a particular SGL locally in hardware before the system moves on to serve the next SGL for a data transfer. The stored SGEs may be used at a later time when returning to a data transfer (e.g., for a subsequent transfer of multicast data) that uses the same SGL. The system overhead in such a multicasting environment may be reduced.

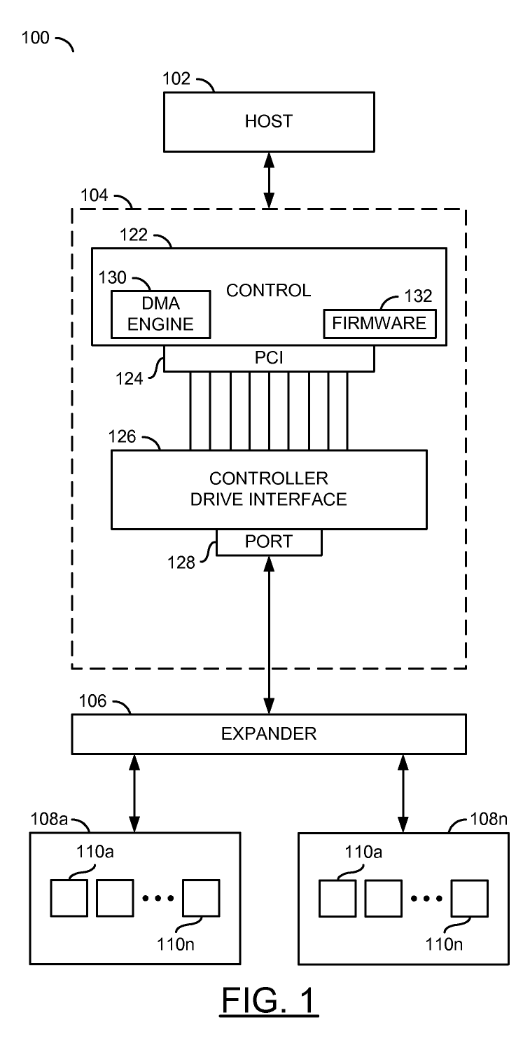

Referring to FIG. 1, a block diagram of a system 100 is shown in accordance with a preferred embodiment of the present invention. The system 100 generally comprises a block (or circuit) 102, a block (or circuit) 104, a block (or circuit) 106, and a plurality of blocks (or circuits) 108a-108n. The block 102 may be implemented as a host (or server). The block 104 may be implemented as a controller. The block 106 may be implemented as an expander (or repeater). The blocks 108a-108n may each be implemented as one or more drives implementing one or more drive arrays 110a-110n. In one example, the drive arrays 108a-108n may comprise a number of solid state storage devices, hard disc drives, tape drives and/or other storage devices 110a-110n. In another example, the blocks 108a-108n may be end user devices. In one example, the devices 110a-110n may be implemented as one or more Serial Attached SCSI (SAS) devices. For example, the devices 110a-110n may be implemented to operate using a SAS protocol.

The controller 104 may include a block (or circuit) 122, a block (or circuit) 124, a block (or circuit) 126 and a block (or circuit) 128. The circuit 122 may include a block (or module) 130 and a block (or module) 132. The circuit 130 may be implemented as a DMA engine. The module 132 may be implemented as firmware (e.g., software, code, etc.). The module 132 may be implemented as code configured to be executed by a processor in the controller 104. In one example, the block 132 may be implemented as hardware, software, or a combination of hardware and/or software.

In one example, the circuit 104 may be implemented as a RAID controller. However, other controllers may be implemented to meet the design criteria of a particular implementation. The circuit 122 may be implemented as a control circuit. The circuit 124 may be implemented as an interface. In one example, the circuit 124 may be implemented as a Peripheral Component Interconnect (PCI) interface slot. In another example, the circuit 124 may be implemented as a PCI bus that may be implemented internally on the controller 104. The circuit 126 may be implemented as a controller drive interface (or a host bus adapter). In one example, the circuit 126 may be a drive controller interface and/or host bus adapter configured to operate as using an SAS protocol. However, the particular type and/or number of protocols may be varied to meet the design criteria of a particular implementation. For example, an internet Small Computer System Interface (iSCSI) protocol may be implemented.

The circuit 126 may include a block (or module) 128. The block 128 may be implemented as an interface circuit (or port). In one example, the interface 128 may be implemented as an interface configured to support a SAS protocol. While an SAS protocol has been described, other protocols may be implemented to meet the design criteria of a particular implementation.

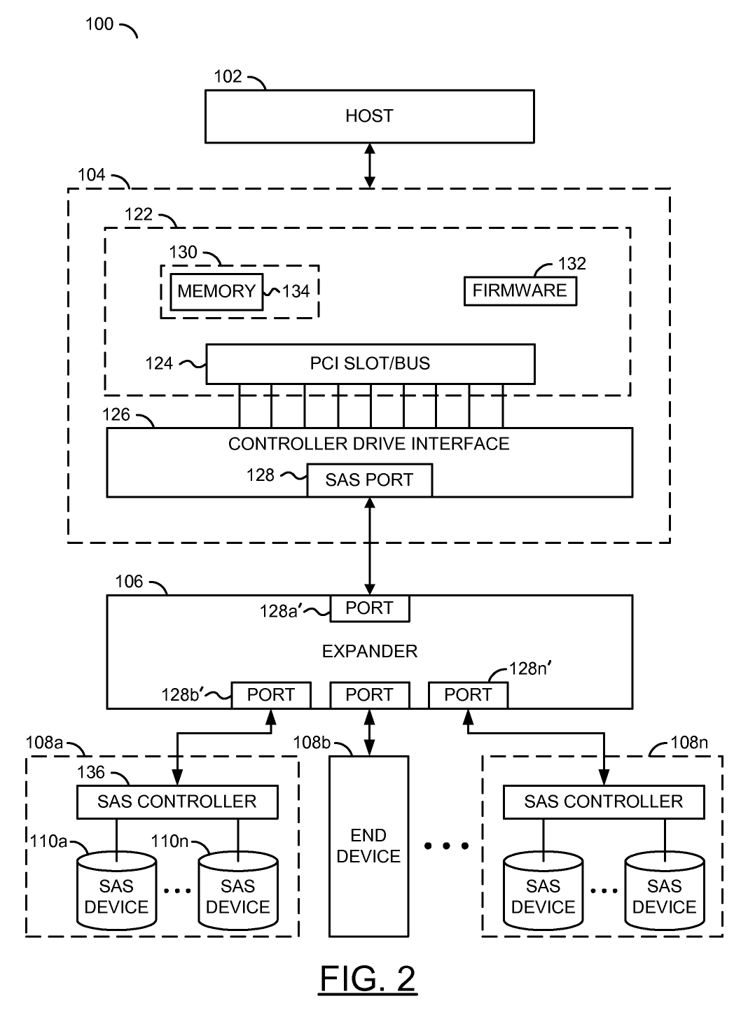

Referring to FIG. 2, a diagram illustrating additional details of the system 100 is shown. The DMA engine 130 may comprise a block (or circuit) 134. The circuit 134 may be implemented as a memory storage portion. In one example, the circuit 134 may be implemented as cache memory. The circuit 134 may be implemented as a Static Random-Access Memory (SRAM), or other appropriate cache memory. The memory 134 may be implemented as either a dedicated memory within the DMA engine 130, or as a portion of a shared and/or dedicated system memory.

Each of the drive arrays 108a-108n may include a block (or circuit) 136. The circuit 136 may be a controller circuit configured to control access (e.g., I/O requests) to the drives 110a-110n. In one example, the drives 110a-110n may be implemented as SAS devices. The SAS port 128 is shown, as an example, connected to a number of the SAS devices 110a-110n. One or more of the SAS devices 110a-110n may be connected directly to the SAS controller port 128. In one example, the SAS expander 106 may connect a plurality of the SAS drives 110a-110n to the port 128.

The system 100 may improve performance by using hardware resources to store one or more SGEs locally in the memory 134. Storing the SGEs in the memory 134 may avoid dumping the SGEs while servicing subsequent SGLs. Data may be transferred quickly by reducing access to the system bus 122 and/or making the SGEs immediately available. The system bus 122 may be made available to other devices to improve overall system efficiency.

In one example, the system 100 may implement “N” number of SGLs, where N is an integer greater than or equal to one. In one example, the system 100 may implement four SGLs. In another example, the system 100 may implement six SGLs. The particular number of SGLs implemented may be varied to meet the design criteria of a particular implementation.

The memory 134 may store two SGL elements (e.g., current element and next pre-fetched element) to enhance the performance. The SGL elements may be read from the host 102. For a particular SGL, there may be two elements available at a given time slot. One example of a multicasting environment may involve four SGLs and may therefore store eight SGL elements inside the memory 134.

The storage devices 108a-108n may be compatible with the specified SGE structures. In one example, the storage devices 108a-108n may be implemented using a Message Passing Interface (MPI). In another example, the storage devices 108a-108n may be implemented as devices compatible with the IEEE SGE (or IEEE SGE-64) format. However, the type of storage device may be varied to meet the design criteria of a particular implementation. The storage devices 108a-108n may store complete details such as SGE pointers, SGE length and/or SGE flags that may include data location information.

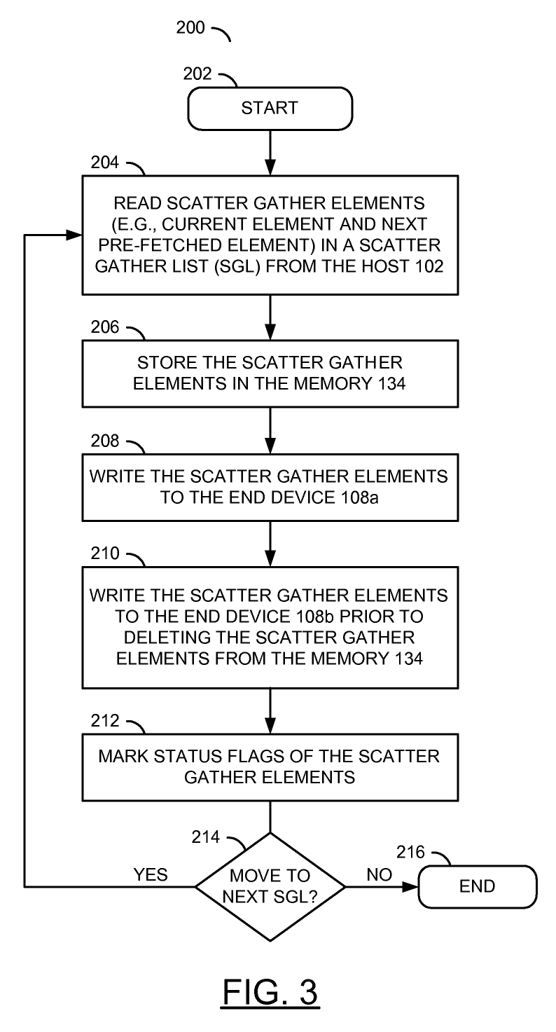

Referring to FIG. 3, a flow diagram illustrating a process 200 for implementing the present invention is shown. The process 200 generally comprises a step (or state) 202, a step (or state) 204, a step (or state) 206, a step (or state) 208, a step (or state) 210, a step (or state) 212, a decision step (or state) 214 and a step (or state) 216. The state 202 may be a start state. The state 204 may read SGEs (e.g., current element and next pre-fetched element) in a SGL from the host 102. The state 206 may store the SGEs in the memory 134. The state 208 may write the SGEs to the end device 108a. The state 210 may write the SGEs to the end device 108b prior to deleting the SGEs from the memory 134. The state 212 may mark status flags of the SGEs. Next, the decision state 214 may determine if a next SGL is available to be read. If yes, the method 200 may loop back to the state 204 to read the next SGL. If no, the method 200 may proceed to the state 216. The state 216 may be an end state.

The DMA engine 130 may move to the next SGL when servicing a particular SGL. Before moving to the next SGL, the DMA engine 130 may store the contents of both elements (e.g., a current and a pre-fetched element) of the SGL. In one example, the contents of both elements may be stored in the memory 134. The DMA engine 130 may also mark the valid flags of the stored elements based upon the current status of the elements. The DMA engine 130 may then move on to the next SGL and start the data transfer by fetching the elements of that particular SGL. The process of fetching the SGEs of a particular SGL may be completed for all the SGLs.

When returning back to a particular one of the SGLs, the DMA engine 130 may be presented with the locally stored elements (e.g., SGEs). The DMA engine 130 may decide, based on the status of the flags associated with the particular elements, whether the DMA engine 130 needs to use the locally stored elements or if the DMA engine 130 needs to fetch the elements from the host 102.

The DMA engine 130 may decode the stored elements and use the current element if the current element is valid (e.g., the status flag is marked as valid). The DMA engine 130 may start the data transfer immediately without delays from the previous location. If the current element is not valid, then the DMA engine 130 may move on to check the status of the presented pre-fetched element. If the pre-fetched element is valid, then the DMA engine 130 may update the local pointers and use the pre-fetched element for the data transfer. If none of the locally stored elements are valid, then the DMA may proceed to fetch the elements from the host 102.

In general, the elements may be stored locally if the elements are valid. Only the DMA engine 130 may know whether to use the locally stored elements or access the host 102 to fetch the elements in the beginning of the data transfer. However, an event may mark the locally stored elements invalid at a later time. In one example, the event may be a reset. In another example, the event may be a clearing/completion of the entire context.

As used herein, the term “simultaneously” is meant to describe events that share some common time period but the term is not meant to be limited to events that begin at the same point in time, end at the same point in time, or have the same duration.

The functions performed by the diagrams of FIG. 3 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally executed from a medium or several media by one or more of the processors of the machine implementation.

The present invention may also be implemented by the preparation of ASICs (application specific integrated circuits), Platform ASICs, FPGAs (field programmable gate arrays), PLDs (programmable logic devices), CPLDs (complex programmable logic device), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The present invention thus may also include a computer product which may be a storage medium or media and/or a transmission medium or media including instructions which may be used to program a machine to perform one or more processes or methods in accordance with the present invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMs (random access memories), EPROMs (electronically programmable ROMs), EEPROMs (electronically erasable ROMs), UVPROM (ultra-violet erasable ROMs), Flash memory, magnetic cards, optical cards, and/or any type of media suitable for storing electronic instructions.

While the invention has been particularly shown and described with reference to the preferred embodiments thereof, it will be understood by those skilled in the art that various changes in form and details may be made without departing from the scope of the invention.

1. A method of implementing a data transfer mechanism to reduce latencies and improve performance when sending a first data element to a plurality of destination locations in a multicast environment, comprising the steps of:
reading said first data element from a main memory of a host;
storing said first data element in a storage portion of a direct memory access (DMA) engine of a controller, wherein said storage portion of said DMA engine is separate from said main memory of said host;
writing said first data element from said storage portion to a first destination of said plurality of destination locations; and
writing said first data element from said storage portion to a second destination of said plurality of destination locations prior to deleting said first data element from said storage portion.

2. The method according to claim 1, further comprising the step of:
storing a second data element as a pre-fetched element prior to deleting said first element.

3. The method according to claim 1, further comprising the step of:
deciding whether to use said first data element from said storage portion of said DMA engine or from said main memory of said host based on one or more status flags, wherein said decision occurs within said DMA controller.

4. The method according to claim 3, wherein said status flags are based upon a current status of said first data element.

5. The method according to claim 1, wherein said first data element comprises a current element.

6. The method according to claim 1, wherein said first data elements comprise one or more of (i) Scatter Gather Element (SGE) pointers, (ii) SGE length, and (iii) SGE flags that include data location information.

7. The method according to claim 2, wherein said first data element and said second data element are Scatter Gather List (SGL) elements.

8. (canceled)

9. The method according to claim 1, wherein said method is implemented using Serial Attached SCSI (SAS) protocol.

10. An apparatus comprising:
a host having a main memory and configured to generate a plurality of data elements to send to a plurality of destination locations in a multicast environment;
a direct memory access (DMA) engine of a controller configured to store (i) a first of said plurality of data elements in a storage portion of said DMA engine and (ii) a second of said plurality of data elements, wherein said storage portion of said DMA engine is separate from said main memory of said host; and
a plurality of end devices configured to write said first of said data elements to a first destination of said plurality of destination locations and to a second destination of said plurality of destination locations, prior to (i) deleting said first of said data elements from said storage portion and (ii) processing said second of said data elements.

11. The apparatus according to claim 10, wherein said DMA engine decides whether to use said data elements from said storage portion or from said host based on one or more status flags.

12. The apparatus according to claim 11, wherein said status flags are based upon a current status of said data elements.

13. The apparatus according to claim 10, wherein said first of said data elements comprises a current element.

14. The apparatus according to claim 10, wherein said second of said data elements comprises a pre-fetched element.

15. The apparatus according to claim 10, wherein said data elements comprise one or more of (i) Scatter Gather Element (SGE) pointers, (ii) SGE length, and (iii) SGE flags that include data location information.

16. The apparatus according to claim 10, wherein said data elements are Scatter Gather List (SGL) elements.

17. (canceled)
